(19) United States
(12) Patent Application Publication
(10) Pub. No.: US 2020/0294248 A1
(43) Pub. Date: Sep. 17, 2020

(54) SYSTEMS AND METHODS FOR IMAGING OF MOVING OBJECTS

(71) Applicants: University of Utah Research Foundation, Salt Lake City, UT (US); Particle Flux Analytics Inc., Park City, UT (US)

(72) Inventors: Tim Garrett, Salt Lake City, UT (US); Sanket Deshmukh, Park City, UT (US); Deep Amin, Salt Lake City, UT (US); Allan Reaburn, Park City, UT (US)

(21) Appl. No.: 16/813,557

(22) Filed: Mar. 9, 2020

Related U.S. Application Data
(60) Provisional application No. 62/815,126, filed on Mar. 7, 2019.

(51) Int. Cl. G06T 7/246; G06T 7/73; H04N 5/232; G06K 9/62

(52) U.S. Cl. CPC G06T 7/246; G06T 7/73; G06T 2207/20081; G06K 9/628; G06K 9/6262; H04N 5/23203

(57) ABSTRACT

An imaging system for capturing movement of an object can include a camera configured to capture image data. The system can also include a first motion sensor and a second motion sensor configured to detect an object; and transmit a motion detection signal to a motion sensor controller indicating the position of the object when it was detected by the first and second motion sensors. The system can further include a motion sensor controller configured to receive the motion detection signal, determine, based on the motion detection signal, whether the object has entered the target space; and generate a camera activation signal in response to determining that the object has entered the target space. The system can also include a camera activation engine configured to receive a camera activation signal from the motion sensor controller, and activate the camera to capture image data of the target space.

### RELATED APPLICATION

This application claims priority to U.S. Provisional Application No. 62/815,126 filed on Mar. 7, 2019, which is incorporated herein by reference.

### SUMMARY

An imaging system for capturing movement of an object is disclosed which can include one or more cameras, a plurality of motion sensors, a motion sensor controller, and a camera activation engine. The camera can be configured to capture image data. The plurality of motion sensors can be transversely arranged to define a target space and configured to detect an object passing through the target space monitored by the plurality of motion sensors and transmit a motion detection signal to a motion sensor controller indicating the position of the object when detected by the plurality of motion sensors. In some examples, the camera and the plurality of motion sensors can be integrated into a common capsule housing via a support frame.

The motion sensor controller can be configured to receive the motion detection signal from the plurality of motion sensors, determine, based on the motion detection signal, whether the object has entered the target space and generate a camera activation signal in response to determining that the object has entered the target space. The camera activation engine can be configured to receive a camera activation signal from the motion sensor controller and activate the camera to capture image data of the target space.

Image data captured by the imaging system may be analyzed to identify one or more object features. In some examples, object features identified in the image data can include insect features, such as body parts of an insect, hydrometeor features, or particle features. The imaging system can classify each object captured in image data into an object group based on object features identified in the image data. In some examples, object groups can be organized such that each object group represents a species of insect. Object features can be used to classify objects captured in image data using a classification algorithm. The classification algorithm can produce a label probability (e.g., a likely object classification) which can be applied to the image data. For example, the classification algorithm can produce a label probability for a type of insect and the label probability can be applied to an image of the insect captured by the imaging system. Also, in some examples, the motion sensor controller can be configured to determine a trajectory of an object passing through a target space. For example, the motion sensor controller may calculate a movement vector based on the speed associated with the object and the direction associated with the object.

There has thus been outlined, rather broadly, the more important features of one or more embodiments so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of example embodiments will be apparent from the detailed description which follows, taken in conjunction with the accompanying drawings, which together illustrate, by way of example, features; and, wherein:

FIG. 1A illustrates an example capsule support frame that that includes an imaging system for capturing movement of an object in accordance with some embodiments.

FIG. 1B illustrates an example capsule support frame that that includes an imaging system with separate camera and motion sensor units for capturing movement of an object in accordance with some embodiments.

FIG. 1C is a schematic illustration of infrared motion sensor assemblies and a corresponding target space in accordance with an embodiment.

FIG. 2 illustrates a flow chart of a method for capturing movement of an object in accordance with some embodiments.

FIG. 3 illustrates a system for imaging falling objects in accordance with an embodiment of the technology.

FIG. 4 is block diagram illustrating an example of a computing device that may be used to execute a method for capturing movement of an object in accordance with some embodiments.

FIG. 5 is a schematic illustration of VGG16 CNN architecture.

FIG. 6 is a modified CNN architecture block diagram.

FIGS. 7A-F are graphical representations of convolutional layer features for a boxelder bug dataset.

FIG. 8 is an accuracy curve for one example training model configuration using non-cropped images.

FIG. 9 is a loss curve for one example training model configuration using non-cropped images.

FIG. 10 is a confusion matrix for one example training model configuration using non-cropped images.

FIGS. 11A-C are class activation maps for one example training model configuration.

FIG. 12 is an accuracy curve for one example training model configuration using cropped images.

FIG. 13 is a loss curve for one example training model configuration using cropped images.

FIG. 14 is a confusion matrix for one example training model configuration using cropped images.

Reference will now be made to the exemplary embodiments illustrated, and specific language will be used herein to describe the same. It will nevertheless be understood that no limitation on scope is thereby intended.

These drawings are provided to illustrate various aspects of the invention and are not intended to be limiting of the scope in terms of dimensions, materials, configurations, arrangements or proportions unless otherwise limited by the claims.

### DETAILED DESCRIPTION

Before technology embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for describing particular examples or embodiments only and is not intended to be limiting. The same reference numerals in different drawings may represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to convey a thorough understanding of various technology embodiments. One skilled in the relevant art will recognize, however, that such detailed embodiments do not limit the overall technological concepts articulated herein, but are merely representative thereof.

As used in this written description, the singular forms “a,” “an” and “the” include express support for plural referents unless the context clearly dictates otherwise. Thus, for example, reference to “a” layer includes a plurality of such layers.

Reference throughout this specification to “an example” means that a particular feature, structure, or characteristic described in connection with the example is included in at least one technology embodiment. Thus, appearances of the phrases “in an example” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the disclosed technology. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of”0 have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” “minimized,” “maximized,” “increased,” “reduced,” and the like refer to a property of a device, component, function, or activity that is measurably different from other devices, components, or activities in a surrounding or adjacent area, in a single device or in multiple comparable devices, in a group or class, in multiple groups or classes, related or similar processes or functions, or as compared to the known state of the art.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases, depend on the specific context.

However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided. Unless otherwise enunciated, the term “about” also generally connotes flexibility of less than 2%, and most often less than 1%, and in some cases less than 0.01%.

The term “coupled,” as used herein, is defined as directly or indirectly connected in an electrical or nonelectrical manner. “Directly coupled” items or objects are in physical contact and attached to one another. Objects or elements described herein as being “adjacent to” each other may be in physical contact with each other, in close proximity to each other, or in the same general region or area as each other, as appropriate for the context in which the phrase is used.

Numerical amounts and data may be expressed or presented herein in a range format. It is to be understood, that such a range format is used merely for convenience and brevity, and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Various techniques, or certain aspects or portions thereof, may take the form of program code (i.e., instructions) embodied in tangible media, such as compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “processor” can include general purpose processors, specialized processors such as central processing units (CPUs), graphics processing units (GPUs), digital signal processors (DSPs), microcontrollers (MCUs), embedded controller (ECs), field programmable gate arrays (FPGAs), or other types of specialized processors, as well as base band processors used in transceivers to send, receive, and process wireless communications.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Digital imaging and automation systems have enabled advanced data capturing techniques. The disclosed technology uses a combination of motion sensors and cameras to, in a power efficient manner, detect moving objects (such as insects or other small airborne objects), capture images of those objects when the object is in a determined space, and classify that object.

In addition, using data from motion sensors (such as where and at what time an object is detected) the imaging system can determine a motion vector for the object including the speed of motion and the direction of the motion. The system can then gather data about the general motion of groups of objects over time. For example, the system can store a record for each object, including the object type and object movement vector. By providing a target space for which entry and exit points can be determined, three-dimensional motion vectors can thus be readily obtained. The system can then analyze a plurality of objects of a certain type and determine whether there is a recognizable pattern or trend in the motion of the objects.

The disclosed technology can enable the efficient tracking and prediction of object movement among other things. In some examples, an imaging system in a housing can be left in a convenient location with a power supply (e.g., a battery or solar power cell) and can collect data without human intervention for a given amount of time. Thus the disclosed technology can allow the efficient collection of large amounts of information about object movement trends without much human intervention. This advantage eliminates expensive and time-consuming manual gathering of movement data and allows information to be more broadly obtainable and usable.

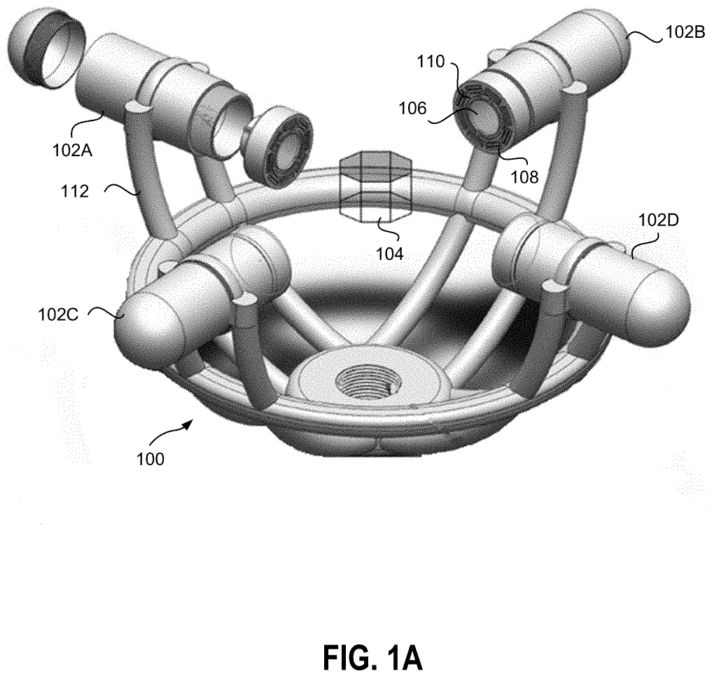

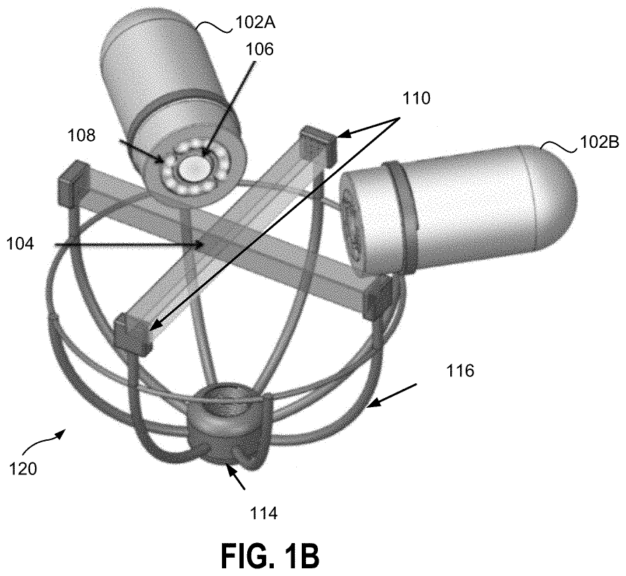

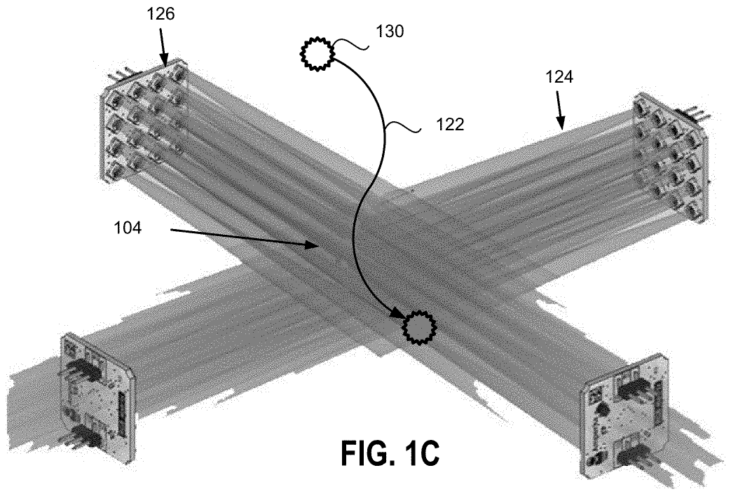

FIG. 1A illustrates an example capsule support frame 100 that includes an imaging system for capturing movement of an object in accordance with some embodiments. The capsule support frame 100 includes a rigid body with a plurality of arms 112, each of which includes a camera 106, one or motion sensors 108, and one or more light sources 110. Each arm 112 may include a receiver canister 102A-D mounted with an opening facing towards the center of the capsule support frame 100, and may be situated to be directly across from a complimentary receiver canister 102A-D. In some examples, the arms 112 of the capsule support frame 100 may be spaced at ninety degree (90) angles from one another.

In some examples, each receiver canister 102A-D includes a series of motion sensor 108 components arrange around the opening of the receiver canister 102A-D in a circle pattern. Each receiver canister 102A-D can be matched with a complimentary receiver canister 102A-D directly opposite from it in the capsule support frame 100. Two complimentary receiver canisters 102A-D each include one component of a motion sensor 108. In some examples, a motion detector comprising the motion sensors 108 may be enabled by transmitting a signal from a first motion sensor 108 configured as a signal transmitter and receiving that signal at a second motion sensor 108 configured as a signal receiver. An interruption in receiving the signal (e.g., electromagnetic radiation in the non-visual spectrum including back-scatter, side scatter, forward scatter or interruption of a visible spectrum laser light) allows the motion detector to infer that an object has passed between the signal transmitter and the signal receiver. Thus, a first receiver canister 102A may include a signal transmitter for the motion detector, and a second receiver canister 102D directly across from the first receiver canister 102A may include a signal receiver for the motion detector, and the space between the two may be a target area 104 covered by the motion detector.

Thus, each pair of receiver canisters 102A/D and 102B/C can have a ring of motion sensors 108 that monitor a target space 104 between them. In this example, the capsule support frame 100 has two sets of receiver canisters 102A/D and 102B/C, each pair monitoring a target space 104 between them. The target space 104 where two cylindered shaped areas overlap may also be referred to as a target volume, area, or sample volume. An object is determined to be in the target area 104 when both sets of motion sensors 108 (e.g., the set of motion sensors 108 associated with the first pair of receiver canisters 102A/D and the set of motion sensors 108 associated with the second pair of receiver canisters 102B/C) detect the object at substantially the same time. Thus, although only two pairs of motion sensors are illustrated in FIG. 1A, any number of motion sensors can be used to form a target volume from an intersection (common space) of overlapping detection volumes. In one alternative, a signal can be emitted by a camera system (e.g. a laser) that is backscattered to the system for detection. Such an alternative would avoid using a pair of sensors.

In another example, a first set of emitter-receiver pairs can form a first cylindrical sensor path. A second set of emitter-receiver pairs can be concentrically oriented about the first set in order to form a second cylindrical sensor path which is concentric and parallel to the first sensor path.

FIG. 1B illustrates an imaging system 120 which includes two orthogonally oriented cameras 102A-B each mounted on a frame 116 about a target space 104 or volume. Two sets of orthogonally arranged IR emitter-receiver pairs 110 are also mounted to the frame 116 in order to define the target area 104. Although each of the cameras 106 and the motion sensor 110 pairs can be oriented orthogonal to one another, any non-parallel arrangement which results in image and beam paths transverse to one another and intersecting at the target area 104 can be used.

When an object passes into the target area 104 (e.g., both sets of motion sensors 110 detect the motion) the cameras 106 can be activated and capture image data of the target area 104. In some examples, one or more light sources 108 can be activated to illuminate the target area 104. In some examples, the cameras 106 can be activated multiple times in a given period and the light sources 108 can be activated for at least part of the period. In other example embodiments, a light source may be activated immediately before, during, and optionally immediately after (i.e. typically less than 1 second) the visual data is captured.

FIG. 1C illustrates one specific example of two orthogonal sets of motion sensors 126 which form a parsable target space 104 or volume. In this example, the sets of motion sensors 126 can include a first array of infrared emitters that can be arranged to correspond to a complementary detector array, while a second array of infrared emitters can have a second complementary detector array. In this case the sets of motion sensors 126 form orthogonal motion detection rays 124 (e.g., infrared (IR) beams) which intersect forming a target space 104, area, or volume. The target space 104 may be formed having overlapping regions such that correlation of interruption of different pairs of motion sensors 126 can allow detection of movement of an object 130 through the target space 104 and trigger a camera(s) to capture an image(s). Interruption of the different pairs of motion sensors 126 can be analyzed to determine an object trajectory 122 of an object 130. For example, a sequence of interruptions of the motion detection rays 124 (e.g., IR beams) can be used to calculate an object trajectory 122 associated with an object 130 that passes through the target space 104. Thus, the target space 104 effectively becomes parsed into sub-volumes which can be independently monitored for interruption. As moving objects traverse the target space 104, different adjacent sub-volumes can be traversed along differing motion detector rays 124, which also triggers the corresponding motion sensors (i.e. one or more detectors within each of the sets of motion sensors 126). Sequential interruptions can be correlated with movement, speed and direction of an object through the target space 104.

These systems having a plurality of motion sensors along each detection ray direction (i.e. co-linear) can produce a parsable target space. In some cases such resolution and trajectory is not needed such that a single motion sensor can be used along each detection ray direction. For example, either a single passive or reflective motion sensor, or a transmitter-receiver pair as a motion sensor can be used. In both cases, motion sensors can be any device which detects movement of an object and include passive or active sensors. Non-limiting examples of motion sensors include passive infrared, microwave, ultrasonic, tomographic, video camera software, time-of-flight sensors, and the like.

In one alternative, the motion sensors can be time-of-flight (ToF) motion sensors. One non-limiting example is Adafruit VL53L0X sensor available from Adafruit. Generally a time of flight sensor works by emitting a laser pulse which is then reflected from the target object and returns to a sensor on the ToF motion sensor. The motion sensor then measures the time taken for pulse to be reflected (i.e. the time of flight) and converts that to a distance. Pulses are emitted continually and so ToF (and hence distance) measurements are performed in real time.

Using two opposed (or non co-linear) ToF motion sensors allows a stereoscopic measurement of distance and so can localize the particle within the two dimensional plane (e.g. similar to FIG. 1A). Using three non-coplanar ToF motion sensors permits the localization of the particle in three dimensions. From sequential measurements one can then quantify both the direction and the speed of motion of the object, and in the three dimensional case this permits measurement of the fall-speed of an object, e.g. precipitation.

In the case of insects, the detection and classification of the insect are typically desired within the target zone and so could utilize a two sensor array. Similarly, in the case of precipitation, both detection and classification of the precipitation as well as a measurement of trajectory are desired such that a three sensor system would be desired.

The geometry of the motion sensor array in the two dimensional case can be any transverse arrangement. In one case the two sensors can be oriented at 90° to each other with overlapping beams that cross in the target zone. However, intersection angles from about 20° to 90° can be suitable. The geometry of a three dimensional array would augment the two dimensional array with a third sensor that is oriented towards the same target volume as the other two sensors but is vertically offset from the other two sensors and located below the plane of the two sensor array. An offset angle out of plane of the two sensors can vary but is generally from about 5° to about 90°.

The systems described above can be controlled and accessed via any suitable user interface. For example, a user can utilize a user interface to perform a variety of operations that, as described in greater detail later, include labeling object images, training a classifier model, predicting labels for object images, select one or more pre-trained classifier models, review labeled object images as well as prediction results, visualize object features, etc. In one example, a user can assign appropriate labels to object images which can be used later for training and analysis of a classifier model. In some examples, users can also configure the system by selecting labeled image datasets, a machine learning algorithm, object features, custom classifier model name, and the like. Parameters for training the respective object classifier model can also be selected by the users. In some examples, users can also select test images and a pre-trained classifier model for the label prediction task. Users can also reject an image based on predetermined criteria.

Images and results can be collected as raw data and optionally organized for display and analysis. For example, classified images can be plotted as a function of various parameters such as, but not limited to, insect type, perimeter to area ratios, population as a function of time, and the like as discussed herein.

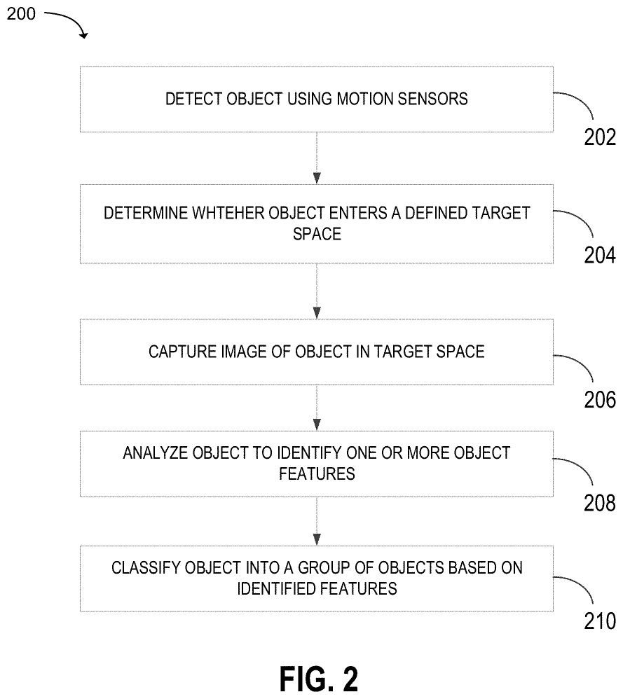

FIG. 2 illustrates a flow chart of an example method 200 for capturing movement of an object in accordance with some embodiments. As in block 202, an imaging system may detect an object using a first and second plurality of motion sensors. As noted above, the motion sensors detect movement of an object when the object passes between a transmitter and a receiver that make up the motion sensor. In some examples, the first and second plurality of motion sensors may be oriented transversely to each other. In one example, each motion sensor can include a signal projector (i.e. a transmitter) and a signal receiver, each oriented with the target space between the signal projector and the signal receiver. In one alternative, a first motion sensor can be arranged non-orthogonally to a second motion sensor. In another example, a first motion sensor can be arranged orthogonally to a second motion sensor. The motion sensors can be arranged such that an overlap of an area monitored by the first motion sensor and an area monitored by the second motion sensor defines a target space, area, or volume within which passing objects can be detected.

As in block 204, the imaging system can determine whether the object enters a defined target space. This determination is made possible because the target space is defined as the intersection between the area monitored by the first set of motion sensors and the area monitored by the second set of motion sensors. Thus, to enter the target space an object will be detected by at least one motion sensor in the first plurality of motion sensors and at least one motion sensor in the second plurality of motion sensors.

In one example, a motion sensor signal can include timing information that identifies which particular motion sensor in the first and second plurality of motion sensors detected the object and when the detection occurred. Determining whether the object has entered the target space can further comprise determining whether a first motion sensor in the first plurality of motion sensors and a second motion sensor in the second plurality of motion sensors both detected the object at a substantially common time. Illustratively, the first motion sensor in the first plurality of motion sensors and the second motion sensor in the second plurality of motion sensors can detect the object within 1/10 of a second, and most often within 1/1000 second, and in some cases within 1/100,000 second depending on object speed, allowing for example, the imaging system to generate a camera activation signal to capture an image of the object.

As in block 206, the imaging system may capture images of the object in the target space. As noted above, the image system can capture a single image or multiple images at a single time or over a period of time. For example, in response to detecting an object within the target space, a camera activation signal can be sent to one or more cameras, causing the cameras to capture an image of the object in the target space. In one example, a motion sensor controller can be configured to generate a motion detection signal that indicates a position of the object within a target space, and the position of the object within the target space can be correlated to a camera oriented to capture image data of a portion of the target space that correlates to the position of the object in the target space. For example, cameras in the imaging system can be oriented to capture images of various portions of a target space, such that each camera covers a different portion of the target space. A position provided in a motion detection signal can be used to identify and activate a camera that covers a portion of the target space containing an object passing through the portion of the target space.

In one example, a motion sensor controller can be configured to detect an object exiting the target space and, in response, generate a vector calculation signal that causes a vector calculation processor to calculate a movement direction for the object. In some examples, detecting whether the object has exited the target space can include determining whether a third motion sensor in the first plurality of motion sensors and a fourth motion sensor in the second plurality of motion sensors both detected the object at a substantially common time. The vector calculation processor can be configured to, in response to receiving a vector calculation signal, determine an entry point location based on an intersection of the first motion sensor and the second motion sensor, determine an exit point location based on an intersection of the third motion sensor and the fourth motion detector sensor, and calculate a movement direction for the object based on the entry point location and the exit point location.

The method 200, in one example, can determine a first time associated with an object crossing an entry point location, determining a second time associated with the object crossing the exit point location, and calculating a speed associated with the object based on a time elapsed between the first time and the second time and the distance between the entry point location and the exit point location. A movement vector can be calculated based on the speed associated with the object and the direction associated with the object. For example, the vector calculation processor can be configured to determine a first time associated with an object crossing an entry point location, determine a second time associated with the object crossing an exit point location, and calculate a speed associated with the object based on a time elapsed between the first time and the second time and the distance between the entry point location and the exit point location. The vector calculation processor can then calculate a movement vector based on the speed associated with the object and the direction associated with the object. For example, whenever the sensor detects an object and the object is within the field of interest (e.g. sample volume), a trigger window can be opened and an initial image can be obtained. Object tracking can then be performed. In one example, sensor positions on X and Y planes can be named as follows:

TABLE 1

| | | | | |
|---|---|---|---|---|
| X0 | 0 | 1 | 2 | 3 |
| X1 | 0 | 1 | 2 | 3 |
| X2 | 0 | 1 | 2 | 3 |
| X3 | 0 | 1 | 2 | 3 |

TABLE 2

| Y0 | Y1 | Y2 | Y3 |
|---|---|---|---|
| 0 | 1 | 2 | 3 |
| 0 | 1 | 2 | 3 |
| 0 | 1 | 2 | 3 |

Here X0 and Y0 represent the top most row. Origin of the 3D is given thus (X₀₀, Y₀₀) in xyz plane this can be represented as (0,0,0). Thus the row number is the Z axis. For all possible positions (Xᵢⱼ, Yₖₗ), i=j since Z plane is unique. Communication time out is t_{com}, which is a maximum amount of time allowed for the microcontroller (MC) to wait for a response on the communication bus. Valid Event time out (t_{ET}) is the maximum amount of time allotted to MC to confirm a Trigger event to be valid or not. A successive valid event time out (t_{VE}) is a maximum amount of time allotted between two valid events. A trigger window t_{w} is the time for which all position indicated “Triggers” are stored. Communication latency tₗₐₜ is the amount of time taken by the master microcontroller to send a communication and receive its response. The microcontroller monitoring X plane is referred to as master. In the following example, “0” represents no trigger, while “1” represents position trigger, and “Z” a non-reactive of not monitored state. Tracking sensor can be reset as:

$$X = ( \begin{matrix}0 & 0 & 0 & 0 \\ 0 & Z & Z & 0 \\ 0 & Z & Z & 0 \\ 0 & 0 & 0 & 0\end{matrix} ) Y = ( \begin{matrix}0 & 0 & 0 & 0 \\ 0 & Z & Z & 0 \\ 0 & Z & Z & 0 \\ 0 & 0 & 0 & 0\end{matrix} )$$

and can continuously scan sensors at a border. When a first trigger is detected: t₀=Clk_{μ} to initiate a new valid event check and save trigger array in the trigger event matrix (Mₜ). All triggers after the 1^{st} trigger are t₁=Clk_{μ}, where if {t₁−t₀≤t_{w}}, then save in trigger event matrix otherwise ignore. If the valid event check is false, then reset; otherwise, initiate secondary object tracking.

For secondary particle tracking, switch sensor monitoring settings with monitoring condition as:

$$X = ( \begin{matrix}Z & Z & Z & Z \\ Z & 0 & 0 & Z \\ Z & 0 & 0 & Z \\ Z & Z & Z & Z\end{matrix} ) Y = ( \begin{matrix}Z & Z & Z & Z \\ Z & 0 & 0 & Z \\ Z & 0 & 0 & Z \\ Z & Z & Z & Z\end{matrix} )$$

When a first trigger is detected, then t₂=Clk_{μ} and initiate a new valid event check. Triggered sensor position array in trigger event matrix is Sₘ. Multiple triggers are recorded as t₂=Clk_{μ}. If {t₁−t₂≤t_{VE}}, then add sensor position to trigger event matrix, otherwise ignore position triggers. If {t₁−t₂≥t_{VE}}, then reset to entry/exit object tracking and clear tᵥ, P₀. If a valid event is confirmed, then set to object tracking mode. Valid event check can be performed and camera and flash can be triggered. Velocity can then be calculated (where d is a distance between two consecutive sensors, and tᵥᵢ is time elapse during each event).

$$X = ( \begin{matrix}Z & Z & Z & Z \\ Z & Z & Z & Z \\ Z & Z & Z & Z \\ Z & Z & Z & Z\end{matrix} ) Y = ( \begin{matrix}Z & Z & Z & Z \\ Z & Z & Z & Z \\ Z & Z & Z & Z \\ Z & Z & Z & Z\end{matrix} )$$

Trajectory values can be calculated from P₀, P₁, P₂, P₃ as:

$$P = \begin{matrix}{x}_{0} & {y}_{0} & {z}_{0} \\ {x}_{1} & {y}_{1} & {z}_{1} \\ {x}_{2} & {y}_{2} & {z}_{2} \\ {x}_{3} & {y}_{3} & {z}_{3}\end{matrix}$$

and velocity as:

$$v = \{ EntryVelocity , Velocity , Exit Velocity \} = \{ \frac{d}{{t}_{v 1} - {t}_{v 0}} , \frac{d}{{t}_{v 2} - {t}_{v 1}} , \frac{d}{{t}_{v 3} - {t}_{v 2}} \}$$

A timeout check can be performed to determine whether a time lapse has exceeded tₒᵤₜ.

In some cases, the imaging system can capture acceleration and higher moments of motion (e.g. jerk) based on data received from the plurality of motion sensors (e.g. changes in acceleration and/or velocity). For example, movement vectors and speed data for an object can be analyzed to identify increases/decreases in acceleration of the object and/or changes in movement of the object. The image system can include a data storage controller configured to store, for each object that passes into the target space, an object type and a calculated movement vector.

Referring again to FIG. 2, as in block 208, the image system analyzes the image data for the object to identify one or more object features. In one example, the features that are identified may be flying object features, such as body parts of an insect. In another example, the features may be hydrometeor features, such as rain, snow, hail, ice pellets, snow pellets (soft hail, graupel), snow grains, or ice crystals. In yet another example, the features may be particle features, such as dust, dirt, pollen, organic matter, fire ash, volcanic ash, explosive debris, nuclear fallout, aquatic species, and the like. Thus, in one optional example, the imaging system can be waterproof and allow for underwater detection of objects.

As in block 210, the imaging system classifies each object into one object group from a plurality of object groups based on the identified features. In one example, the imaging system can include an image processing engine configured to analyze captured image data and identify one or more features of the object. For example, the image processing engine may perform feature extraction where the image processing engine can be configured to use machine learning and/or pattern recognition to detect and isolate various portions or shapes (i.e., features) contained in image data.

In one example, the imaging system can include a classifying engine configured to sort each object into one of a plurality of categories based on the identified features of the object. Each category can represent a type of insect, hydrometeor, or particle, as can be appreciated. Identified features can be assigned to a category and stored in a storage database. For example, a feature can be assigned a label probability (e.g., a probability that a feature is associated with a particular type of object) that the feature belongs to a category.

In one example, object groups can be organized such that each group represents a type of object, such as a species of insect, type of hydrometeor or particle. In classifying objects, classification algorithms receive inputs used to determine unique characteristics associated with different types of objects (e.g. insects, hydrometeors, or particles). Non-limiting examples of such inputs can include perimeter to area ratio, size, aspect ratios, color contrast (ratio of dark to light), area with holes, box perimeter ratios (i.e. bounding box perimeter to object perimeter), centroid distance ratio, circumperimeter ratio, complexity (i.e. ratio of perimeter to effective circumference), convexity, correlation, eccentricity, energy (i.e. angular second moment), Gabor phase mean (x1, x2, y1, y2), Gabor phase standard deviation (x1, x2, y1, y2), time stamp, and the like. Such inputs can be calculated using any suitable image processing to extract these features from collected image data.

Once relevant input features are calculated these features can be used to classify the objects using a suitable classification algorithm. Such classification models can include, but are not limited to, neural networks (e.g. random forest, decision tree, etc.), multinomial logistic regression, and the like. Ultimately, the classification algorithm produces a corresponding label probability (i.e. likely object classification) which can then be applied to the object. In one example, a Fourier transform can be applied to image data to calculate a sloped power spectrum. Phase relationships can also be used to reconstruct images. For example, a Gabor filter can be used to calculate phase relationships. Phase relationships such as Gabor phase means and Gabor phase standard deviations. Gabor features are derived from the application of Gabor filter to the region of interest (ROI). The Gabor filter is a linear filter with a Gaussian kernel which is modulated by a sinusoidal plane wave. The phase is calculated using real and imaginary components returned by the Gabor filter. The Gabor filter can be applied to the ROI with eight orientations and two frequencies each. The frequency may be sensitive to the edges/texture changes in the ROI. The orientations identify the texture changes in respective directions. Orientations can vary from 0 to π radians. For the object analysis, mean and standard deviation in phase gradient that is calculated along x and y directions for the set of two frequencies (e.g., 0.25 and 0.125) are used as features to be fed to a machine learning classification algorithm.

As a non-limiting example, images collected by the imaging system can be collected and analyzed to produce usable output. For example, various features can be extracted to get information on pixel intensity, phase, shape, etc. of the selected object. The information extracted from the images can then be input to the machine learning algorithms to train the classifier model. Such algorithms, except a neural network based classifier, use the feature information extracted from the images for training and prediction tasks. On the other hand the neural network based classification algorithm may take a whole image as input and compute the relevant features and determine the label using the trained neural network.

Classification models tend to improve with larger and balanced datasets for each class of object. For example, datasets of one hundred (100) or greater can be suitable, although datasets of tens of thousands can improve accuracy of classification. Small datasets may not contain all variations to discover (or accurately recognize) hidden patterns/representations in the dataset. Furthermore, balanced datasets include images having a variety of features, such as insect angles, limb positions, etc. Hence, data augmentation techniques can be utilized to increase a number of images in a training dataset by adding synthetic variations to the existing images. Such data augmentation techniques can include, but are not limited to, image rotation, random brightness variation, image mirroring, and the like. Image rotation takes copies of the existing image rotated by fixed degrees (e.g. 90, 180, or 270°) which helps in reducing overfitting of the model for a specific orientation of the object in the images. Random brightness variation takes copies of the existing image with random variations in the brightness which is also used for training and helps in better generalization of the classifier model for different lighting conditions. Image mirroring takes horizontally and vertically mirrored copies of the existing image to further generalize the training classifier model for orientations.

As an example, an image gradient model can be used for the detection of blurred object images. For a clear image, the gradient histogram distribution is dense towards low gradient values and also exists for some large values. On the other hand the gradient distribution for a blurred image is almost empty for large gradient values. A histogram of gradients can be formed of features extracted for images which can then be used as a training dataset for a machine learning classification model. In another alternative aspect, the image processing can include a rejection criteria by which a collected image is rejected. Reasons for rejecting a collected image can include, but are not limited to, failure to fall within the sample volume, poor focus, incomplete image, too small, and the like.

In another example, an artificial neural network (ANN) can be used for image classification. The ANN may be made up of several layers of such neurons that are connected to all the other neurons in previous layers. The neuron is the smallest processing unit in the ANN. The neuron has connections with other neurons. The input passes through these connections and then the neuron is subjected to an activation function that enables the neuron to react to only specific inputs. The ANN model combines the activations of large number of neurons from different layers of the network to learn representation of the complex datasets. Such a trained model can be used for decision making tasks such as image recognition. ANN Layers in a neural network are simply a collection of neurons. There are three basic types of layers: (1) Input: inputs are fed to the network through input layer; (2) Hidden: this layer processes the input data received from previous layers (input/hidden) and pass it on the next layer that could be hidden or the output layer; and (3) Output: this layer provides the data processed by previous layers in the specific format required for the decision making.

Activation functions adds the non-linearity to the model. This helps to ANN to learn complex representations/patterns in the dataset. A weighted sum of all the inputs coming to a neuron are subjected to this activation function. The weights are assigned randomly in the beginning and then gets updated according the specific task for which the ANN is trained. The output of an activation function is then passed on to the neurons in the next layer as inputs.

The learning in ANN begins with the randomly initialized weight values for all the connections between the neurons. The input data is then passed through all the layers of neurons with the respective activation function to get the prediction value. This process is also known as Forward Pass. The predicted value is then compared to the ground truth values to calculate the error also known as loss. This loss can then be propagated back (also known as Back Propagation) to all the layers in the ANN as a feedback. The model learns the hidden patterns in the dataset by minimizing the loss. The connection weights get updated during the loss minimization. Stochastic Gradient Descent Optimizer is one commonly used optimizer for the loss minimization.

The learning rate decides the magnitude of the update in the connection weights during training (loss minimization) of the ANN model. In other words, the learning rate defines the step size taken towards the minima during optimization. A low learning rate makes it slower for a model to learn while the high learning rate helps in fast learning but has a risk of missing out on the minima and then oscillate around the minima.

An inference may be a forward pass run on the test inputs using the trained ANN model. The ANN uses the raw image pixels as an input to the network. The convolution filter layers are then used to extract the features from the image. As the pixels in the images are spatially correlated, the small filter blocks used in convolution helps in identifying the features, such as the horizontal and vertical lines, edges, as well as more complex features such as irregular curves, shapes, etc. as the network gets deeper.

This architecture of ANN that uses the convolution layers for feature extraction is also knows as the Convolutional Neural Network (CNN). The CNN is made up of the input layer, stacked up convolution layers, fully connected hidden layers, and the final output layer. The convolution layers learn the basic features in the initial layers and then go on to learning complex features in the deep network layers. The features learned through the convolutional layers are then passed through the fully connected hidden layers and then through the output layer.

Pooling layers are often used in between the convolution layers to reduce the feature space as well as to increase the generalization in the predictions. This avoids the overfitting of the model. There are several architectures available for image recognition tasks that use the basic convolution layers for feature extractions. Non-limiting examples include: Inception Model, VGG16, VGG19, ResNet, etc. These architectures have evolved in recent years through ImageNet Large Scale Visual Recognition Competition. These models can be trained on approximately half a million images for detection of 200 categories. CNN can thus be used for image classification.

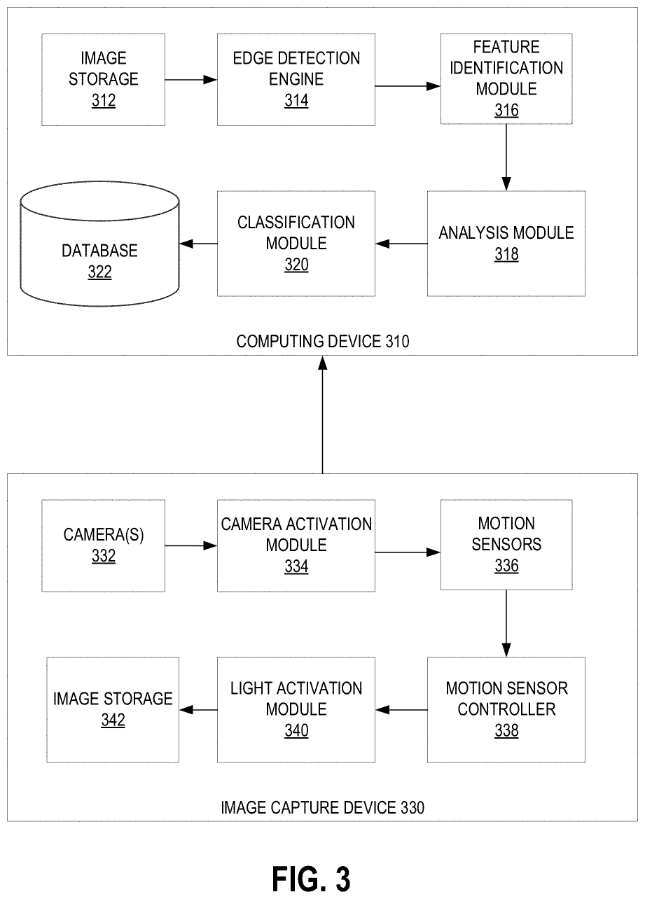

FIG. 3 illustrates a system for imaging objects in accordance with an embodiment of the technology. The system includes a computing device 310 and an image capture device 330. The image capture device includes a motion sensor controller 338, motion sensors 336, as well as one or more cameras 332 and light activation modules 340. Cameras 332 can be used to capture images of objects and the captured images can be stored on an image storage device 342. The operation of the various components of the image capture device 330 has been described in further detail above.

The computing device 310 in this example may be separate from the image capture device 330. The allocation of components between the computing device 310 and the image capture device 330 can vary with different applications and designs. The computing device 310 can include a personal computer, a networked server, or any other of a variety of different types of computing devices. In one example, the computing device 310 may be a server or virtual machine located in a service provider environment (e.g., a “cloud” environment) and the computing device 310 may host one or more of the components shown in FIG. 3. In one example, the computing device 310 can further comprise a plurality of computing devices. For example, the image capture device 330 can be in electronic communication with a server (e.g., a computing device 310) and the image capture device 330 can transmit captured images from an image storage device 342 to another image storage device 312 located on the server. A user can access the images from the server via a workstation computing device to process the images with the various modules shown as components of the computing device. Other configurations of systems are also contemplated and are considered within the scope of this disclosure.

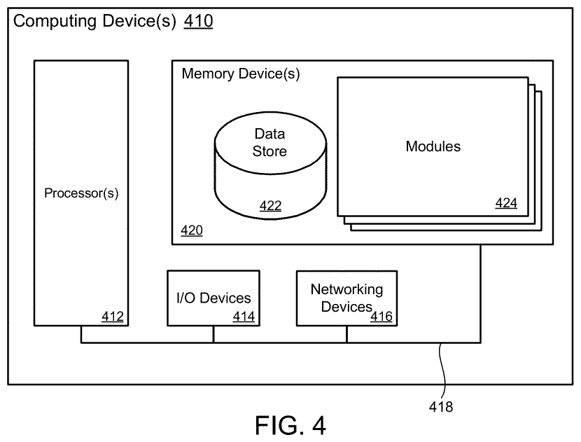

For simplicity, the computing device 310 in FIG. 3 is illustrated as a single computing device. However, one or more of these modules can be provided by multiple computing devices (as shown in FIG. 4) which may be parallelized or otherwise cooperatively communicate. The computing device 310 can receive captured or stored images from the image capture device 330. The computing device 310 can optionally store the received images on an image storage device 312, such as a hard drive, optical disc, flash memory, and the like. The computing device 310 can include a feature detection module 316 for detecting edges of the object captured in the images. A classification module 320 can be in communication with an object database 322 for identifying an object type based on the detected images. The object database 322 can include a plurality of object types defined by object structure, such as edges. In one example, an image reconstruction module (not shown) can reconstruct a digital model of the imaged object for analysis by an analysis module 318. The analysis module 318 can also receive input from the classification module 320 to use in performing the analysis. The operations of the various modules and components of the computing device have been described in further detail above.

In one alternative example, the image classification module can be embedded as part of the camera unit. For example, an ASIC or GPU can be used as computation as part of the camera unit.

FIG. 4 illustrates a computing device 410 on which modules of this technology may execute. A computing device 410 is illustrated on which a high level example of the technology may be executed. The computing device 410 may include one or more processors 412 that are in communication with memory devices 420. The computing device 410 may include a local communication interface 418 for the components in the computing device. For example, the local communication interface 418 may be a local data bus and/or any related address or control busses as may be desired.

The memory device 420 may contain modules 424 that are executable by the processor(s) 412 and data for the modules 424. In one example, the memory device 420 may include an edge detection engine module, feature identification module, analysis module, classification module, and other modules. In another example, the memory device 420 may include a camera activation module, a motion sensor controller module, a light activation module, and other modules. The modules 424 may execute the functions described earlier. A data store 422 may also be located in the memory device 420 for storing data related to the modules 424 and other applications along with an operating system that is executable by the processor(s) 412.

Other applications may also be stored in the memory device 420 and may be executable by the processor(s) 412. Components or modules discussed in this description that may be implemented in the form of software using high-level programming languages that are compiled, interpreted or executed using a hybrid of the methods.

The computing device may also have access to I/O (input/output) devices 414 that are usable by the computing devices. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor(s) 412. The term “executable” may mean a program file that is in a form that may be executed by a processor 412. For example, a program in a higher level language may be compiled into machine code in a format that may be loaded into a random access portion of the memory device 420 and executed by the processor 412, or source code may be loaded by another executable program and interpreted to generate instructions in a random access portion of the memory to be executed by a processor. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 412 may represent multiple processors and the memory device 420 may represent multiple memory units that operate in parallel to the processing circuits. This may provide parallel processing channels for the processes and data in the system. The local communication interface 418 may be used as a network to facilitate communication between any of the multiple processors and multiple memories. The local communication interface 418 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

### EXAMPLE 1

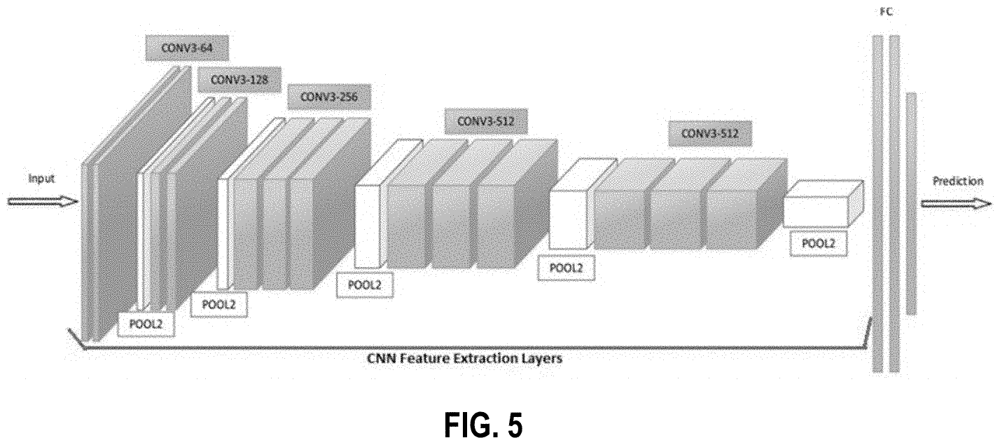

FIG. 5 shows an example VGG16 architecture. Based on the simplicity of the architecture and initial baseline performance, the VGG16 architecture was selected for the study of insect classification. The VGG16 model was trained on around half million images for 200 categories. Special techniques, such as data augmentation and transfer learning, can be used to effectively train a CNN for insect classification with a small dataset. For example, data augmentation as discussed in earlier sections. Transfer learning can also be effective in training the CNN for small datasets.

Transfer learning focuses on storing the knowledge gained while solving a problem and using it for another problem. Transfer learning utilizes the pretrained CNN models for feature extraction and train new fully connected layers for specific image categories. The pretrained models were trained from scratch on the ImageNet Dataset for 200 categories. Such models can be reused/retrained for new categories as basic features extracted for the images remain same for most of the image recognition tasks.

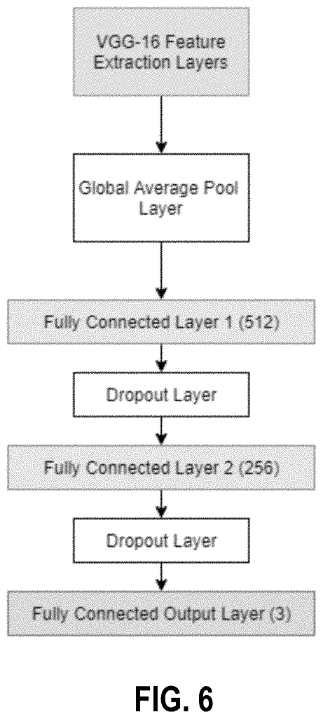

The VGG16 model was modified for the insect classification task. The pretrained convolution blocks were extended with the Global Average Pooling layer followed by the two blocks of the dense (fully connected) hidden layer and the dropout layers and the final fully connected output layer. The dropout layers act as regularizers to avoid overfitting in the model. The Global Average Pooling layer reduces the feature space by averaging the features from stacked up convolutional layers. FIG. 6 shows the modified architecture block diagram.

The transfer learning utilizes the pretrained feature extraction layers for solving the new problem. In the image recognition applications, the features from the pretrained models that were trained for similar objects to the new one, perform better than the features learned from scratch using small dataset. Due to the limited small dataset available for insects, the features extraction layers from VGG16 model (one of the powerful classification models) are used without any modification.

Thus, visualized feature activation maps can indicate that the model extracts information about the shape of an insect, the background, the texture/patterns (e.g. dots on ladybug body) on the insect body, different body parts such as wings, legs, abdomen, etc. This information was extracted in convolutional layers using the pre-trained filters/kernels. In some cases, the first convolutional layer takes raw pixels of the image as input. The pooling layers placed after convolutional layers consolidates the activated features and also reduces the dimensionality. At the end of all the convolution and pooling layers, a final feature vector of length 512 can be obtained. This feature vector can then be used to train the insect classifier.

### EXAMPLE 2

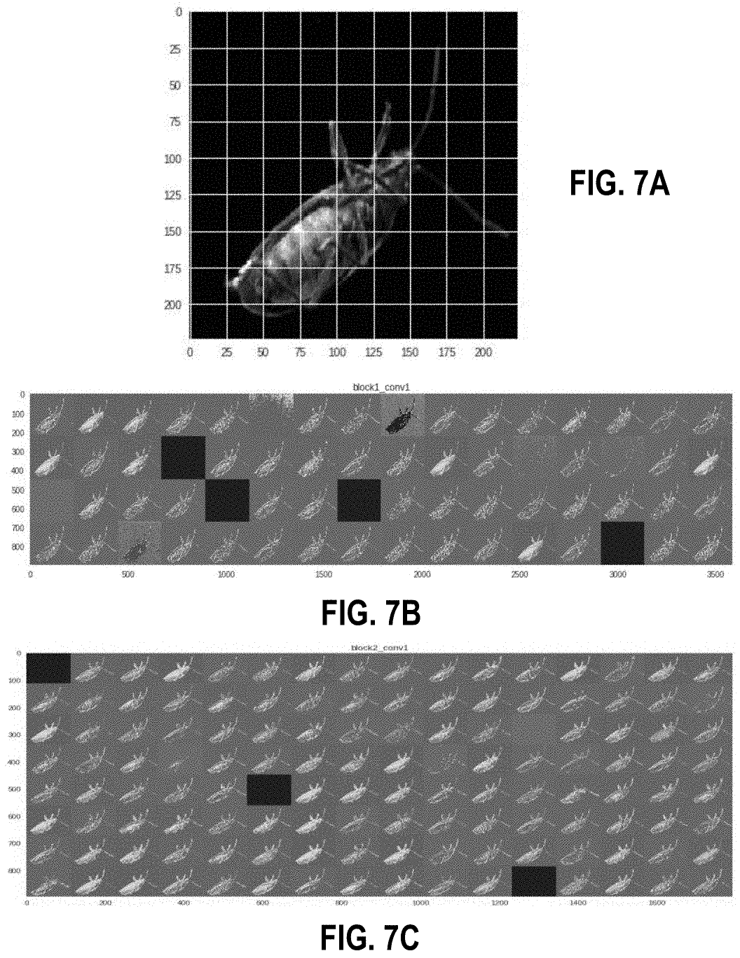

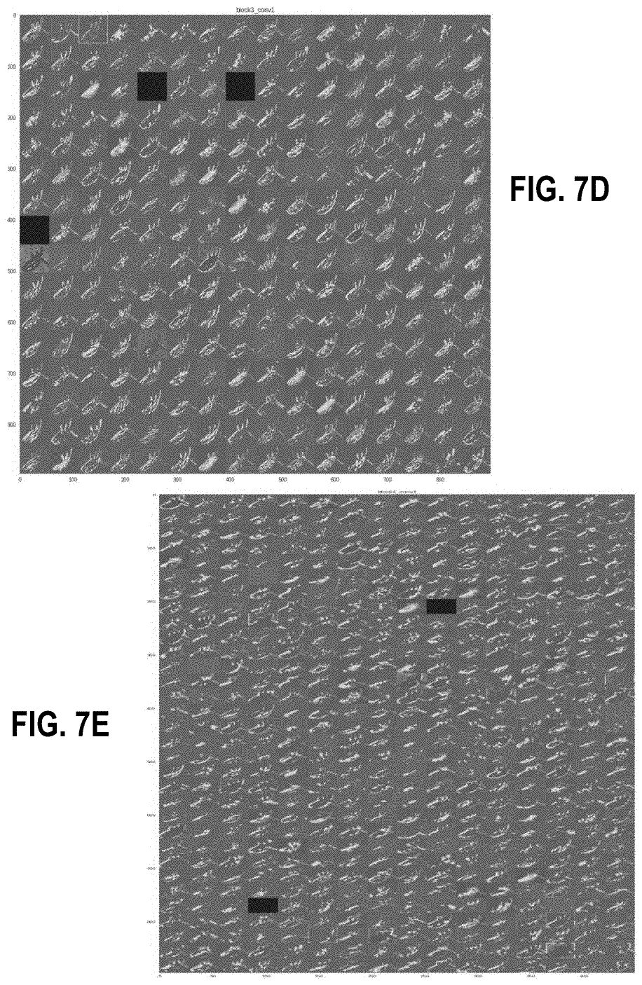

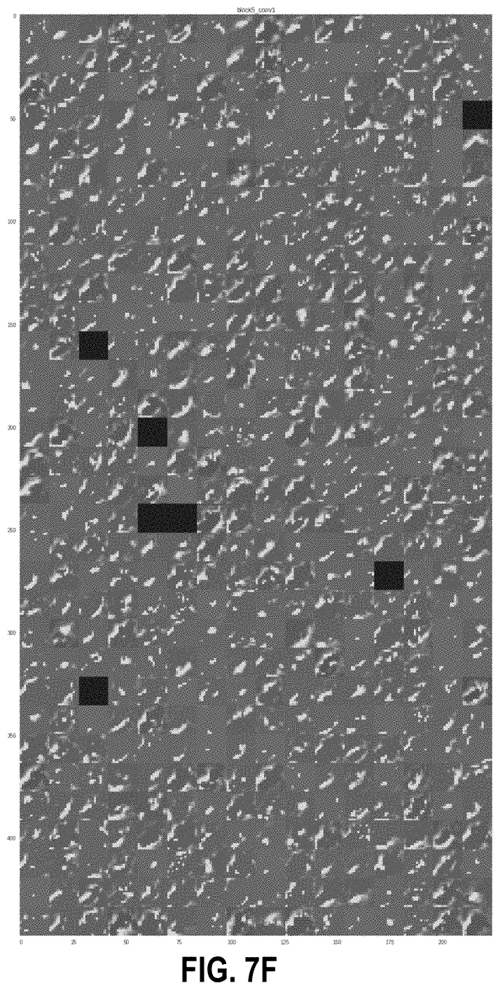

FIGS. 7A-F are graphical representations of convolutional layer features for a sample image in a box elder bug dataset. The images show the activated neurons in the respective layers for the given images. The visual representation shows that the shapes, outlines, background, etc. features are being extracted accurately.

Two sets of the dataset were prepared for the study. One of the datasets included full scale images obtained from MASC preprocessed to remove IR emitter reflections. The other dataset included manually cropped images. The classification categories were boxelder bug, ladybug, and housefly.

Keras library in python comes with the standard VGG16 model architecture and the pretrained weights. This built in model was first loaded and initialized to begin the training. Only the convolution layers were kept for the feature extraction and were extended with the new randomly initialized fully connected hidden layers and the output layer to predict the three classes. The features extraction layers were kept in frozen state to avoid any updates. Only the newly added layers were trained for identification of the insects. The following sections discuss the trained models and their performance.

The Model uses input images with a same size. The MASC captures the images with size 1048×1248. Due to the lack of resources to process the large images during convolution, the images were resized to the 512×512 dimensions that could be managed without exhausting all the computing resources.

The model training configuration included 558 training images belonging to three classes (augmented), 186 validation images belonging to three classes (augmented), using binary cross entropy as loss function, and 50 epochs.

TABLE 3
Test Image Accuracy (46 images across three classes)

| Data | Accuracy | Loss |
|---|---|---|
| Test Data | 0.7753623309342758 | 1.601926705111628 |
| Training Data | 0.9964157708229557 | 0.010787125332005602 |
| Validation Data | 0.9103942898011976 | 0.3651878963555059 |

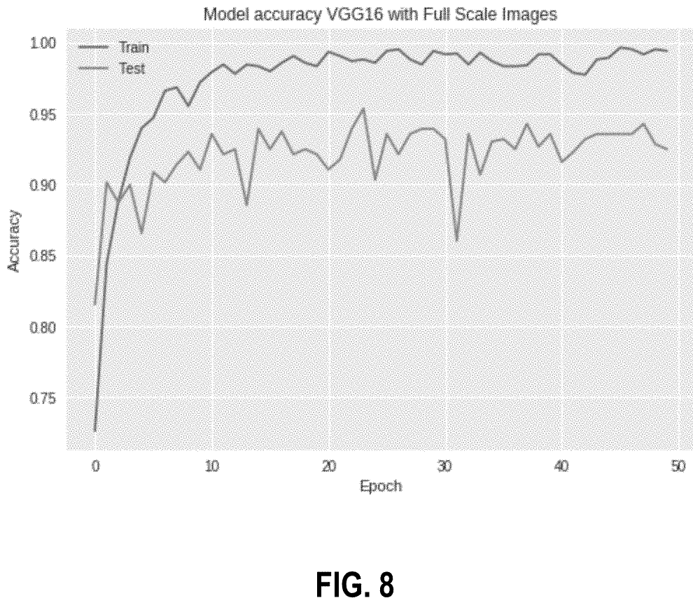

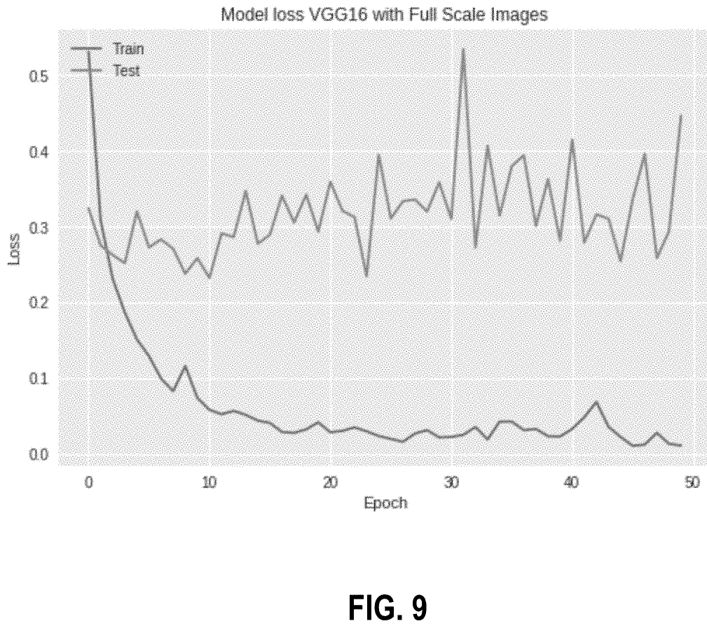

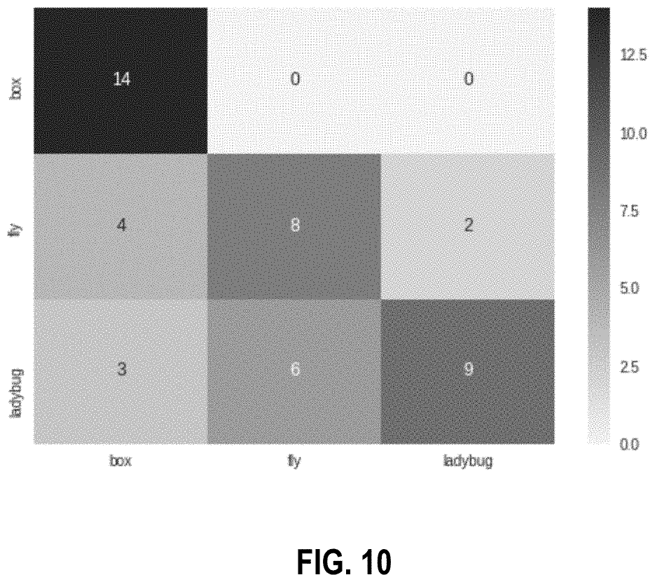

FIGS. 8 and 9 are accuracy and loss curves showing improvement in the model accuracy as a function of epochs. FIG. 10 shows that the training with the full-scale insect images resized to 512×512 resulted in poor performance. The loss curve indicate overfitting which can be validated from the accuracy data. The training accuracy is nearly 100% while the test Accuracy is only around 77.5%. This overfitting occurs when the model is learns the classification on training data but cannot identify the patterns to be used for classification of the unseen images during test run. The confusion matrix (FIG. 10) shows that model learned to identify the boxelder bugs accurately, but had difficulties in identifying the ladybug and house fly. Larger training datasets may increase accuracy.

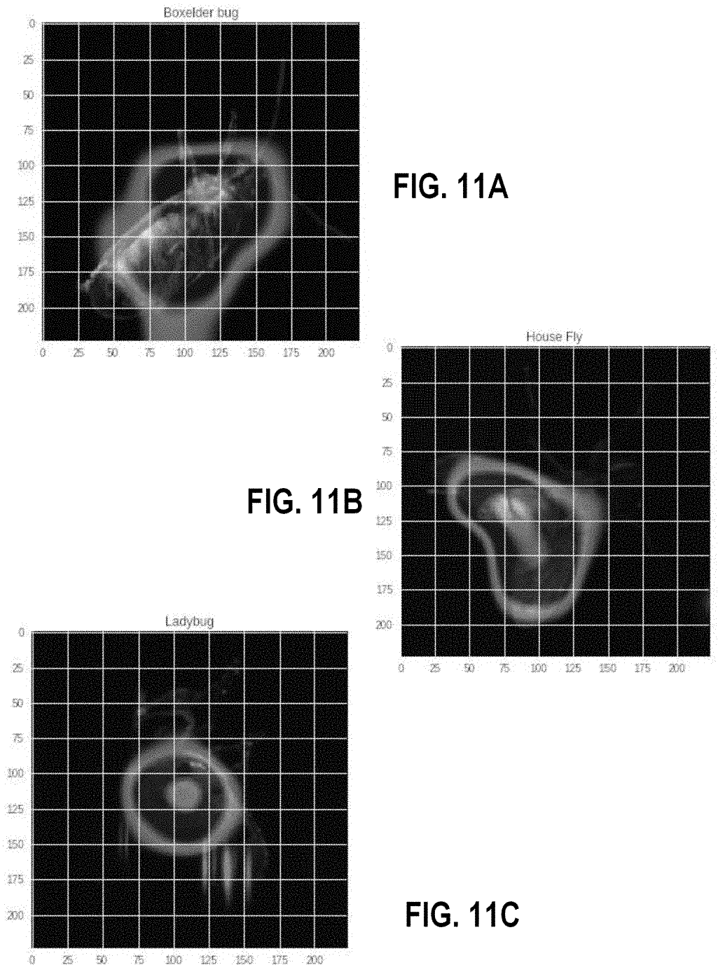

Class activation maps can be used to visualize the patterns/features specific to the class that are learned by the model. The model can then make the decision based on these features. Sample images from each class can be superimposed with the class activation maps for the corresponding classes as illustrated in FIGS. 11A-C. The class activation map highlights the parts of the image that contributed to the decision.

### EXAMPLE 3

The above approach was repeated using cropped images. The cropped images vary in the dimensions. Images input to the model were of same shape for the training. The VGG16 model was trained for the images with size 224×224. Hence all the cropped images were first resized to 224×224. The model architecture layers with total trainable parameters in each layer is given below.

As the feature extraction convolution layers are kept frozen, there were only 394,755 parameters available for the update/training. The rest of the parameters were listed as ‘Non-trainable.’ The model training configuration included 654 training images belonging to three classes (augmented), 218 validation images belonging to three classes (augmented), using a binary cross entropy loss function, and 50 epochs.

TABLE 4
Test Image Accuracy (39 images across
three classes, no augmentation)

| Data | Accuracy | Loss |
|---|---|---|
| Test Data | 0.9145299242093012 | 0.7528867033811716 |
| Training Data | 0.998980632068914 | 0.0020512911199256694 |
| Validation Data | 0.9663608664766364 | 0.10335599523413619 |

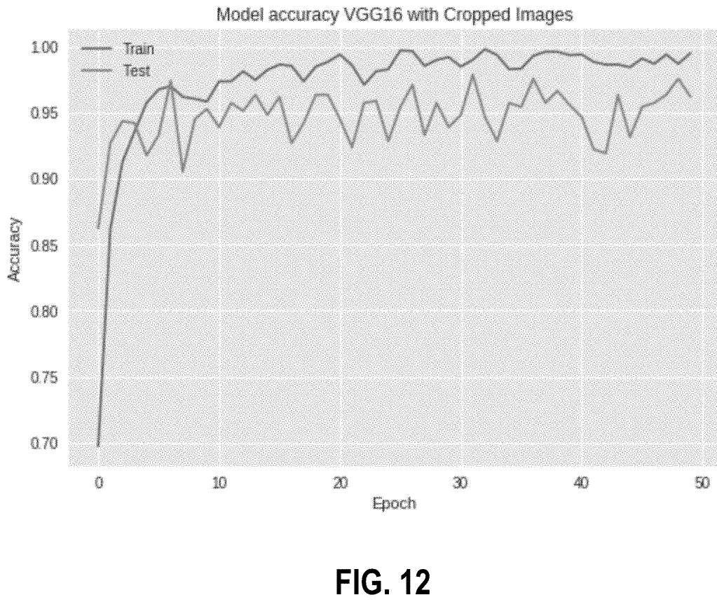

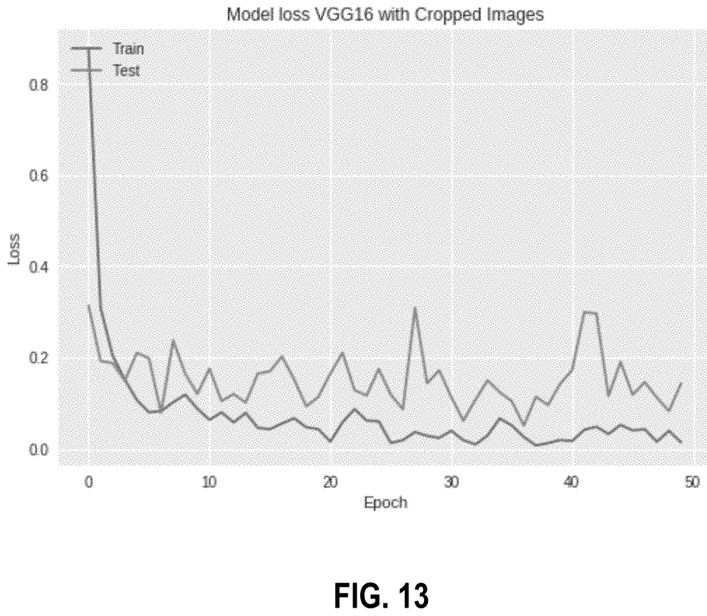

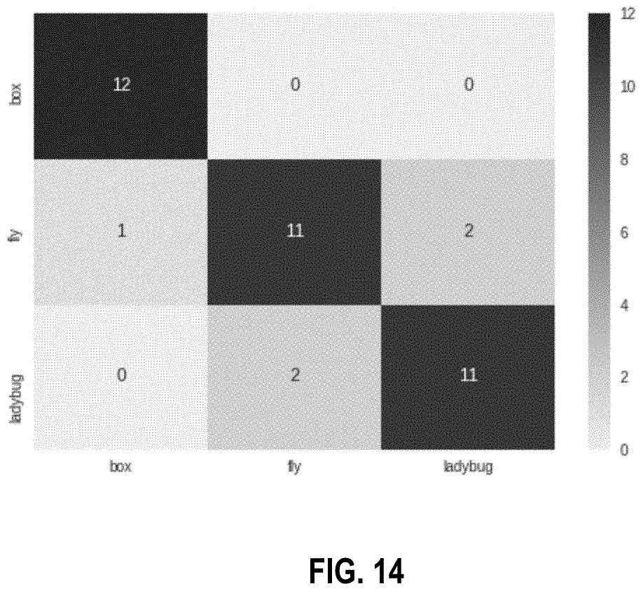

The classifier model trained with the cropped images performed better compared to the one trained with full scale images as seen in FIG. 12. In FIG. 13, the loss curve did not show signs of overfitting meaning the model could learn specific patterns to identify different insects. The confusion matrix (see FIG. 14) shows the performance of the model with the unseen images. This model could identify ladybug and house fly with greater accuracy.

The training experiments showed that the model trained on the cropped images showed better performance compared to the one trained on full scale images. This behavior is attributed to the features used from the transfer learning. The original model was trained for small 224×224 images containing large objects. The full-scale images used for training when resized to reduce the shape, which in turn reduces the actual object size and remains susceptible to a lot of background noise. Hence the overfitting and degraded performance. The model with cropped images did not over fit during the training and showed and performed better apparently due to the greater object coverage in the image less background noise.

A larger dataset of good quality insect images can thus be expected to perform well to train the entire model including the feature extraction layers from scratch. For the full-scale images along with the retraining the model from scratch, the additional object localization algorithms could improve the performance and accuracy of the model.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An imaging system for capturing movement of an object, the system comprising:
a camera configured to capture image data;
a first and second motion sensor transversely arranged to define a target space and configured to:
detect an object passing through the target space monitored by the first and second motion sensors; and
transmit a motion detection signal to a motion sensor controller indicating a position of the object within the target space when the object is detected by the first and second motion sensors;
the motion sensor controller being configured to:
receive the motion detection signal from the first and second motion sensors;
determine, based on the motion detection signal, that the object has entered the target space; and
generate a camera activation signal in response to determining that the object has entered the target space; and
a camera activation engine configured to:
receive the camera activation signal from the motion sensor controller; and
activate the camera to capture image data of the target space.

2. The imaging system of claim 1, wherein each motion sensor includes a signal projector and a signal receiver each oriented with the target space between the signal projector and the signal receiver.

3. The imaging system of claim 1, wherein the first sensor is arranged non-orthogonally to the second sensor.

4. The imaging system of claim 1, wherein the first sensor is arranged orthogonally to the second sensor.

5. The imaging system of claim 1, wherein the first and second sensors each include a plurality of motion sensors arranged such that an overlap of an area monitored by the first plurality of motion sensors and an area monitored by the second plurality of motion sensors defines the target space.

6. The imaging system of claim 5, wherein the motion sensor signal includes timing information identifying which particular motion sensors in the first and second plurality of motion sensors detected the object and when the detection occurred, wherein determining whether the object has entered the target space further comprises:
determining whether a first motion sensor in the first plurality of motion sensors and a second motion sensor in the second plurality of motion sensors both detected the object at a substantially common time.

7. The imaging system of claim 1, wherein the motion sensor controller is further configured to:
after generating a camera activation signal, detect the object exiting the target space; and
in response to detecting the object exiting the target space, generate a vector calculation signal.

8. The imaging system of claim 7, wherein determining whether the object has exited the target space further comprises:
determine whether a third motion sensor in the first plurality of motion sensors and a fourth motion sensor in the second plurality of motion sensors both detected the object at a substantially common time; and wherein the system further comprises: a vector calculation processor configured to, in response to receiving a vector calculation signal:
determine an entry point location based on an intersection of the first motion sensor and the second motion sensor;
determine an exit point location based on an intersection of the third motion sensor and the fourth motion sensor; and
calculate a movement direction for the object based on the entry point location and the exit point location; and optionally wherein the vector calculation processor is further configured to:
determine a first time associated with the object crossing the entry point location;
determine a second time associated with the object crossing the exit point location; and
calculate a speed associated with the object based on a time elapsed between the first time and the second time and a distance between the entry point location and the exit point location.

9. The imaging system of claim 1, further comprising an image processing system configured to:
analyze the captured image data to identify one or more features of the object; and
store the identified features in a storage database, and the system further comprising a classifying engine configured to:
sort each object into one of a plurality of categories based on the identified features of the object.

10. The imaging system of claim 9, wherein each category represents a type of insect.

11. The imaging system of claim 9, the system further comprising:
a data storage controller configured to store, for each object that passes into the target space, an insect type and a calculated movement vector, and wherein the classifying engine is further configured to:
access stored data for a plurality of objects; and
analyze the data for the plurality of objects to identify at least one movement pattern for at least one type of insect.

12. The system of claim 1, wherein the first and second motion sensors are passive infrared motion sensors or time-of-flight motion sensors.

13. A system for capturing movement of an object, comprising:
at least one processor;
a memory device including instructions that, when executed by the at least one processor, cause the system to:
receive a motion detection signal indicating that an object has been detected passing through a target space monitored by a first and second motion sensors, wherein the first and second motion sensors are transversely arranged to define the target space
initiate a camera activation signal in response to receiving the motion detection signal that causes at least one camera to capture image data of the target space containing the object;
extract one or more object features of the object from the image data; and
classify the object represented in the image data based on the one or more object features identified in the image data.

14. The system in claim 13, wherein the motion detection signal indicates a position of the object within the target space, and the position of the object within the target space is correlated to a camera oriented to capture image data of a portion of the target space correlating to the position of the object in the target space, and wherein the memory device further includes instructions that, when executed by the at least one processor, cause the system to: initiate an image processing engine configured to analyze the image data and identify the one or more object features of the object.

15. The system in claim 14, wherein the memory device further includes instructions that, when executed by the at least one processor, cause the system to:
initiate a classifying engine configured to classify the object into one of a plurality of categories based on the object features of the object, wherein the classifying engine generates a label probability for an object type and applies the label probability to the object represented in the image data, and
wherein the memory device further includes instructions that, when executed by the at least
one processor, cause the system to:
collect image data for a plurality of objects;
extract object features from the image data for the plurality of objects; and
input the object features to a machine learning model to train the classifying engine.

16. A computer implemented method for capturing movement of an object, comprising:
receiving an indication that an object has been detected moving through a target space by a first and second motion sensor transversely arranged to define the target space;
sending a camera activation signal to a camera to cause the camera to capture image data of the target space containing the object; and
providing the image data for feature extraction and classification of the object represented in the image data based on one or more object features identified in the image data.

17. The computer implemented method of claim 16, wherein each motion sensor includes a signal projector and a signal receiver each oriented with the target space between the signal projector and the signal receiver.

18. The computer implemented method of claim 16, wherein the first sensor is arranged orthogonally to the second sensor.

19. The computer implemented method of claim 16, wherein the first and second sensors include a plurality of sensors and are arranged such that an overlap of an area monitored by the first plurality of motion sensors and an area monitored by the second plurality of motion sensors defines the target space.

20. The computer implemented method of claim 19, further comprising:
determining, when object movement is detected, which particular motion sensors in the first and second plurality of motion sensors detected the object and when the detection occurred, and determining whether the object has entered the target space further comprises:
determining whether a first motion sensor in the first plurality of motion sensors and a second motion sensor in the second plurality of motion sensors both detected the object at a substantially common time.

21. The computer implemented method of claim 16, wherein the motion sensor controller is further configured to:
after generating a camera activation signal, detect the object exiting the target space; and
in response to detecting the object exiting the target space, generate a vector calculation signal.

22. The computer implemented method of claim 21, wherein determining whether the object has exited the target space further comprises:
determining whether a third motion sensor in the first plurality of motion sensors and a fourth motion sensor in the second plurality of motion sensors both detected the object at a substantially common time, and further comprising, in response to receiving a vector calculation signal:
determining an entry point location based on an intersection of the first motion sensor and the second motion sensor;
determining an exit point location based on an intersection of the third motion sensor and the fourth motion detector sensor; and
calculating a movement direction for the object based on the entry point location and the exit point location;
determining a first time associated with the object crossing the entry point location;
determining a second time associated with the object crossing the exit point location;
calculating a speed associated with the object based on a time elapsed between the first time and the second time and a distance between the entry point location and the exit point location; and
calculating a movement vector based on the speed associated with the object and the direction associated with the object.

23. The computer implemented method of claim 16, further comprising:
analyzing the captured image data to identify one or more features of the object; and
storing the identified features in a storage database.

24. The computer implemented method of claim 23, further comprising:
sorting each object into one of a plurality of categories based on the identified features of the object.

25. The computer implemented method of claim 24, wherein each category represents a type of insect, and the method further comprising:
storing, for each object that passes into the target space, an insect type and a calculated movement vector.
